(19) United States
(12) Patent Application Publication
(10) Pub. No.: US 2005/0047762 A1
(43) Pub. Date: Mar. 3, 2005

(54) Motor speed control device

(76) Inventors: Cheng-Chieh Liu, Taoyuan Hsien (TW); Yao-Lung Huang, Taoyuan Hsien (TW); Ming-Shi Tsai, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/776,510

(22) Filed: Feb. 12, 2004

(30) Foreign Application Priority Data
Aug. 28, 2003 (TW) 092123690

(51) Int. Cl. H02P 5/06

(52) U.S. Cl. 388/806

(57) ABSTRACT

A motor speed control device. The motor speed control device applied to a direct current (DC) fan includes a driving element constituted by a driving IC and Hall IC, a thermal sensor and a control element electrically connected between the driving element and the thermal sensor. The present invention utilizes a thermal sensor and a simple control element to effectively and stably control the variable speed of the fan within different temperature ranges.

### BACKGROUND OF THE INVENTION

1. Field of the Invention

The present invention relates to a motor speed control device, and in particular to a motor speed control device applied to a direct current (DC) fan.

2. Description of the Related Art

Traditionally, when electronic devices function under heavy load, cooling fans operate at full speed. However, under light loading, fans generally continue to operate at full speed, wasting power, generating unnecessary noise, and reducing fan life. Accordingly, a method to control the rotation speed of the fan has been developed. As shown in FIG. 1, when an electronic device functions under light loading, its inner temperature remains low. A thermistor RTH detects the temperature variation, adjusts its resistance accordingly, adjusts voltage and current from the power source, and outputs a signal to a driving circuit IC, which outputs a pulse width modulation (PWM) to a transistor TR, the switch frequency of which varies with duty cycle of the PWM signal, adjusting average current to the motor of the fan. Controlled rotation speed of the fan motor is thus achieved. The control theory is shown in FIG. 2 by way of explanation, in which supply voltage Vcc is 12V. The thermistor RTH detects temperature and accordingly generates voltage VTH. Reference voltage V0 drives the fan at low speed. The duty cycle with the lowest driving voltage is determined by comparing oscillation voltage of the PWM signal and the reference voltage V0. The duty cycle modulation is controlled by comparing the oscillation voltage of the PWM signal and the voltage VTH from low speed from full speed. The fan functions at full speed if temperature exceeds a specific value. When the inner temperature increases, thermistor RTH decreases resistance, and the current increases to increase rotation speed, providing suitable heat dissipation. When the temperature decreases again, the thermistor RTH again increases resistance, thus decreasing the rotation speed of the fan.

However, as shown in FIG. 1, a voltage drop occurs at V_{CE} terminal of the transistor TR in the work area. The transistor consumes much power and generates heat accordingly. Also, when power consumption is too high or input voltage from the power source is too low, the thermistor RTH cannot function normally, thereby generating excess heat and increasing the inner temperature of the computer system.

### SUMMARY OF THE INVENTION

An object of the present invention is to provide a motor speed control device applied to a fan for controlling its rotation speed in different temperature ranges by a thermistor and a simple external circuit, easily controlling turning points of temperature when the fan functions at a relatively low speed.

Accordingly, the motor speed control device of the present invention includes a thermal sensor detecting an environmental temperature of the fan, a driving element driving the fan to a specific rotation speed according to the detected temperature, and a control element connected electrically between the driving element and the thermal sensor for adjusting the first voltage of the thermal sensor to change the rotation speed and temperature range of the fan, wherein the thermal sensor is preferably a thermistor, and the driving element includes a Hall sensor and a driver IC.

Preferably, the control element is a switch circuit including a comparator, a transistor, and two resistors, wherein one resistor of the switch circuit is electrically connected in parallel with the thermal sensor such that the first voltage rapidly decreases to be less than the reference voltage of the driving element to turn on the transistor and reduce the temperature range of the fan to the full speed.

Alternatively, the control element includes a resistor electrically connected in serial with the thermal sensor and controlling the temperature range of the fan to the full speed by adjusting the resistance of the resistor and reducing the variation of the first voltage.

The control element can be a subtraction circuit including a comparator and at least four resistors, wherein three resistors of the subtraction circuit form a second voltage to adjust a third voltage output to the driving element to reduce the temperature range of the fan to the full speed.

Alternatively, the control element can be constituted by a division circuit, a comparator, and an output circuit, wherein when the first voltage exceeds the reference voltage of the driving element, the output circuit outputs a voltage equal to the reference voltage to be input to the driving element to keep the fan rotate at a low speed, and when the first voltage is smaller than the reference voltage of the driving element, the voltage input to the driving element is divided by N through the division circuit to quickly drive the fan to a full speed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of the control circuit of the conventional fan.

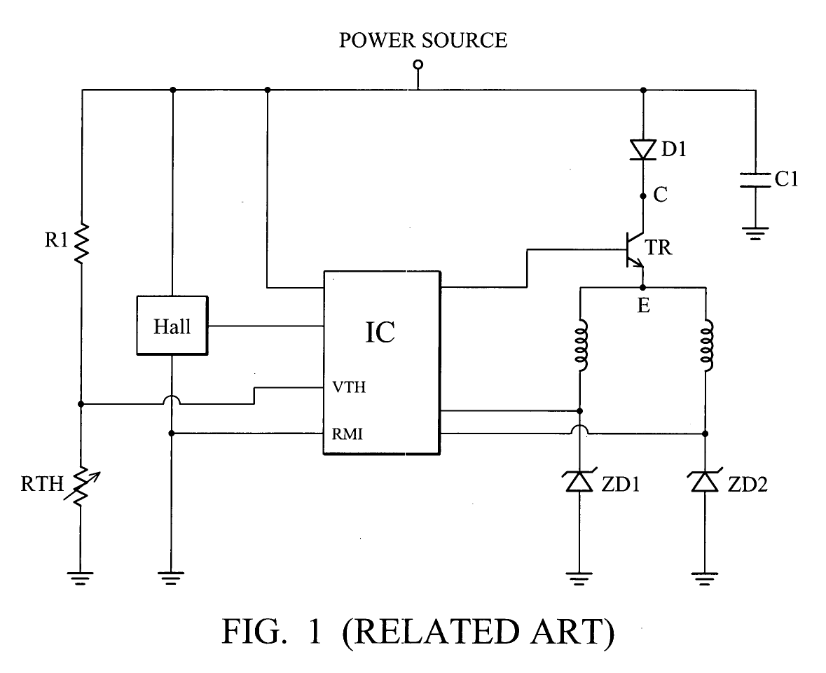

FIG. 2 is a plot of control theory concerning the control circuit of the conventional fan.

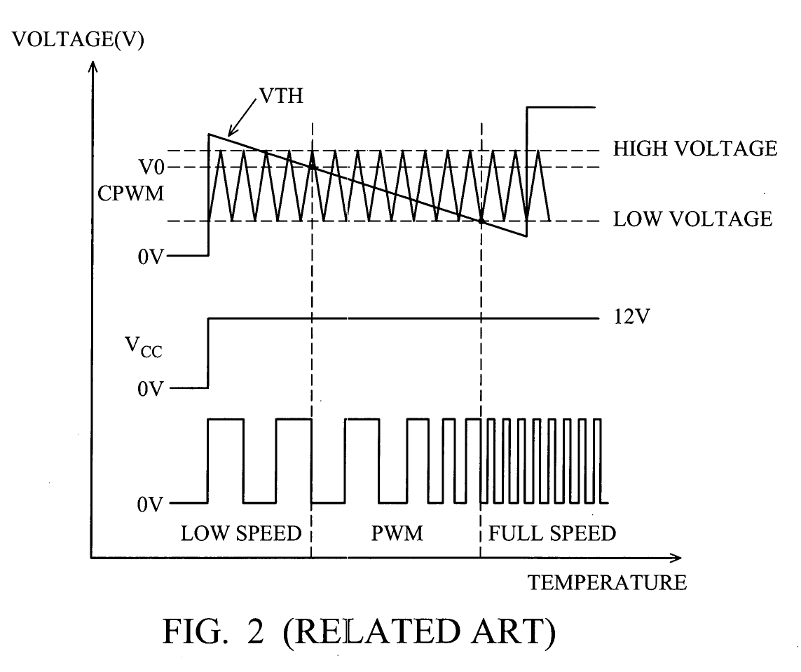

FIG. 3A is a schematic diagram of the first embodiment of the motor speed control device of the present invention.

FIG. 3B plots variation between the temperature and rotation speed in the first embodiment of the motor speed control device of the present invention.

FIG. 4A is a schematic diagram of the second embodiment of the motor speed control device of the present invention.

FIG. 4B plots variation between the temperature and rotation speed in the second embodiment of the motor speed control device of the present invention.

FIG. 5A is a schematic diagram of the third embodiment of the motor speed control device of the present invention.

FIG. 5B plots variation between the temperature and rotation speed in the third embodiment of the motor speed control device of the present invention.

FIG. 6 is a schematic diagram of the fourth embodiment of the motor speed control device of the present invention.

### DETAILED DESCRIPTION OF THE INVENTION

First Embodiment

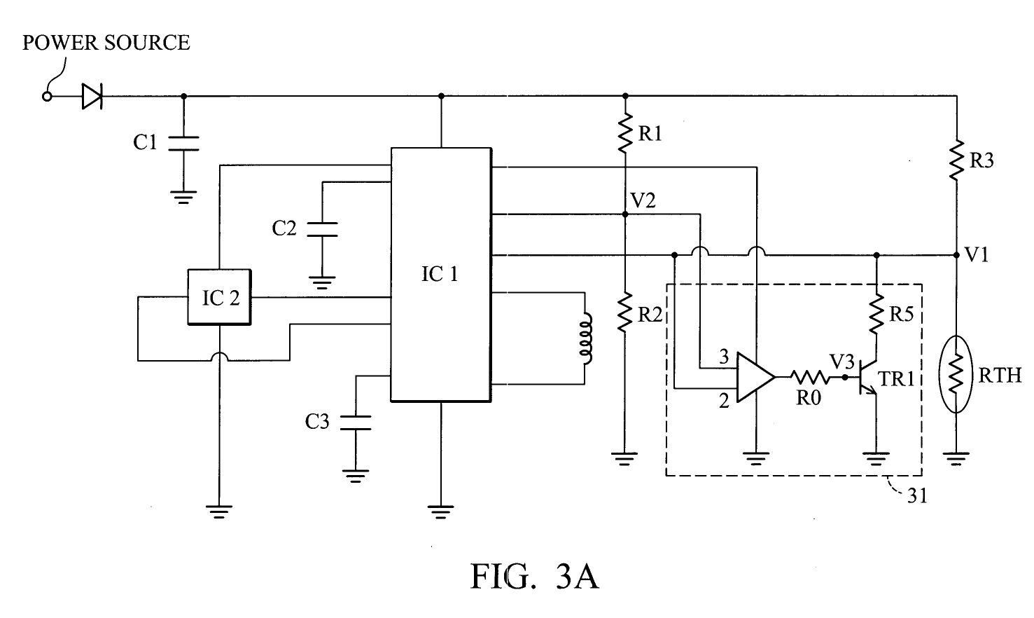

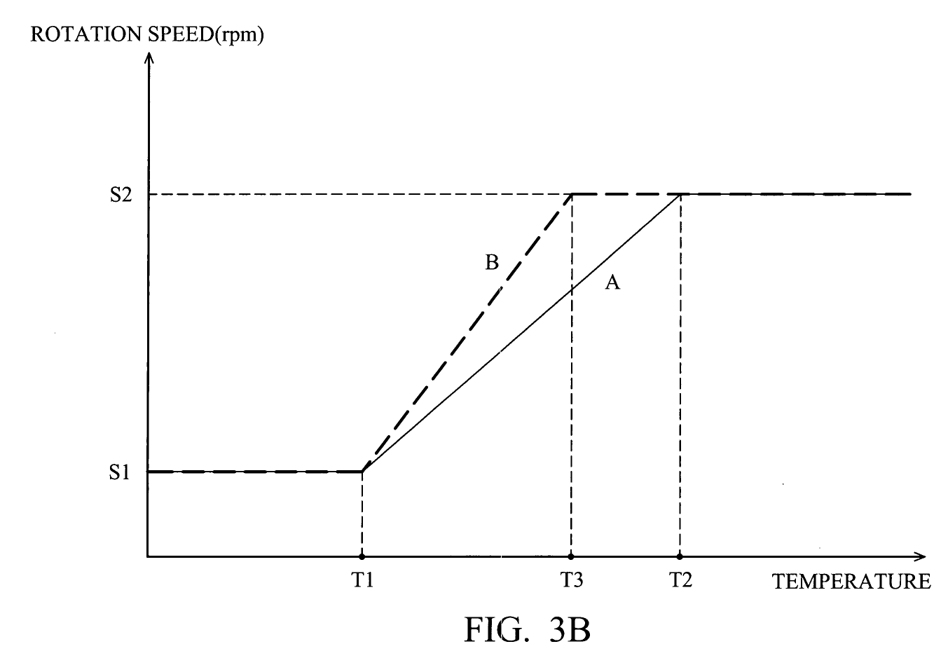

FIG. 3A is a schematic diagram of the first embodiment of the motor speed control device of the present invention. As shown in FIG. 3, a power source supplies voltage to start fan rotation by inter-induction between winding coils and magnetic rings of the motor. A Hall induction integration circuit IC2 detects electric waves induced by magnetic field variation between winding coils and magnetic rings of the fan. After, the Hall induction IC IC2 outputs two positive and negative voltages to a driving integration circuit IC1. Thus, the circuit IC1 and the circuit IC2 constitute a driving element to drive the fan and send a feedback periodic pulse signal.

As well, the driving element is connected to a thermal sensor (or a thermistor) RTH and a switch circuit, wherein the switch circuit 31 includes a comparator, a transistor TR1, and two resistors R0 and R5 (as indicated by the dotted line in FIG. 3A). The thermal sensor RTH has various resistances at different temperatures, whereby first voltage V1 from thermal sensor RTH and the resistor R3 varies with temperature. Second voltage (or reference voltage) V2 is formed by the resistors R1 and R2. A comparator compares the first voltage V1 and the second voltage V2, and accordingly adjusts the third voltage V3 output therefrom. Therefore, the current varies when the transistor TR1 is turned on, and the rotation speed of the fan varies accordingly, thus achieving the goal of speed control by temperature.

FIG. 3B plots variation between the temperature and rotation speed in the first embodiment of the motor speed control device of the present invention. FIG. 3B shows variations in the slope between temperature and rotation speed of the fan before and after the circuit IC1 is connected with the switch circuit. Without the switch circuit, the slope from temperature T1 to T2 is A. With the switch circuit, the resistor R5 and the thermal sensor RTH are connected in parallel, the first voltage V1 drops rapidly such that the reference voltage V2 exceeds the first voltage V1, and the transistor TR1 is turned on, thus reducing temperature range of speed variation (from T1 to T3). The slope B from temperature T1 to T3 exceeds the slope A without the switch circuit, so rotation speed of the fan is raised from low S1 to high S2 rapidly and sharply. Temperature range of speed variation is thus reduced by controlling the first voltage V1.

Second Embodiment

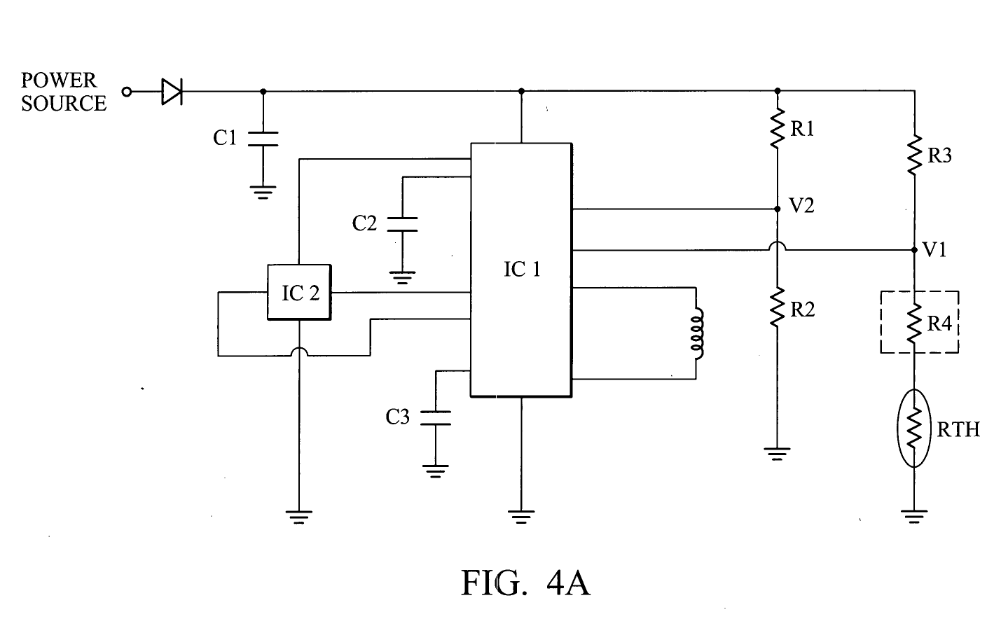

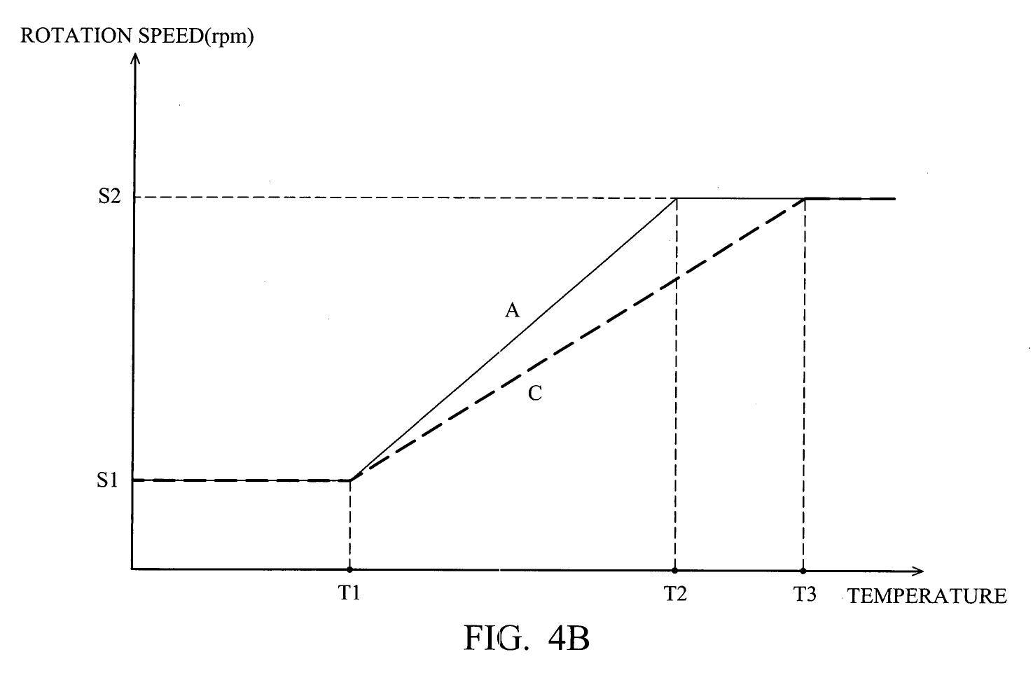

FIG. 4A is a schematic diagram of the second embodiment of the motor speed control device of the present invention. As shown in FIG. 4A, the detailed circuit and control theory are similar to those in the first embodiment. The difference between these two embodiments lies in a resistor R4 electrically connected with the thermal sensor RTH in series in this embodiment, unlike the switch circuit of the first embodiment.

FIG. 4B plots variation between the temperature and rotation speed in the second embodiment of the motor speed control device of the present invention. FIG. 4B shows variations in the slope between temperature and rotation speed of the fan before and after the resistor R4 is connected with the thermal sensor RTH in series. Without the resistor R4, the slope from temperature T1 to T2 is A. After the resistor R4 is connected with the thermal sensor RTH in series, variation of the first voltage V1 decreases. Temperature range from T2 to T3, controlled by the resistance of the resistor R4, presents a smaller slope C.

Third Embodiment

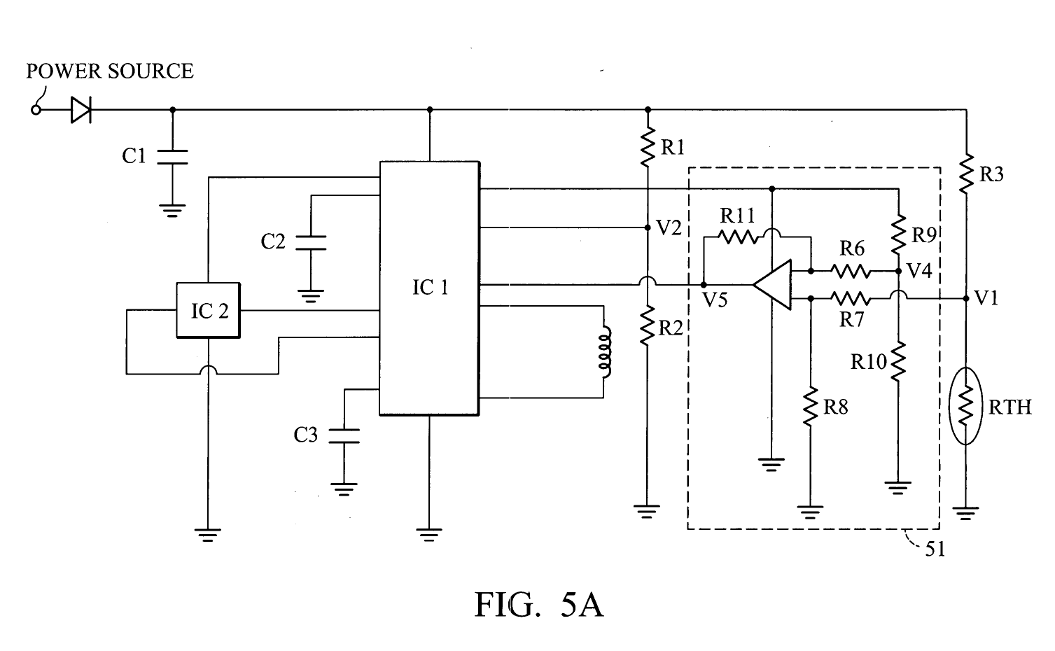

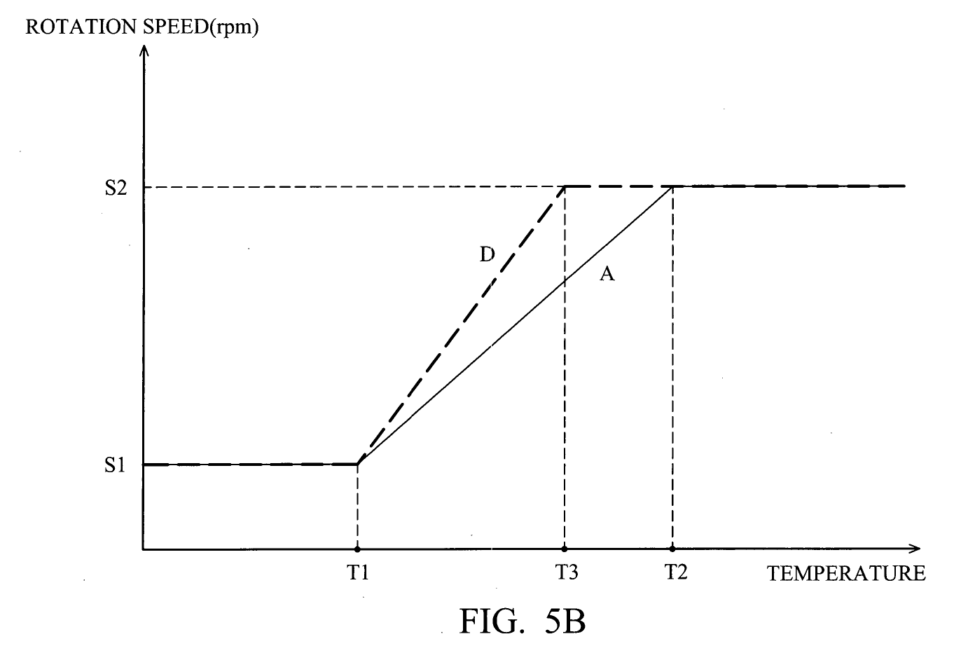

FIG. 5A is a schematic diagram of the third embodiment of the motor speed control device of the present invention. As shown in FIG. 5A, the detailed circuit and control theory are similar to those in the first embodiment. The difference between these two embodiments lies in a subtraction circuit 51 of this embodiment replacing the switch circuit of the first embodiment. The subtraction circuit 51 includes a comparator and six resistors R6, R7, R8, R9, R10, and R11, as indicated by the dotted line in FIG. 5A.

FIG. 5B plots variation between the temperature and rotation speed in the third embodiment of the motor speed control device of the present invention. As shown in FIG. 5B, when resistances of the resistors R6, R7, R8, and R11 are equal, voltage V5 equals voltage of voltage V4 taken away from voltage V1. Temperature range of the fan at full speed is thus reduced by adjusting fourth voltage V4, whereby the slope changes from A to a larger value D.

Fourth Embodiment

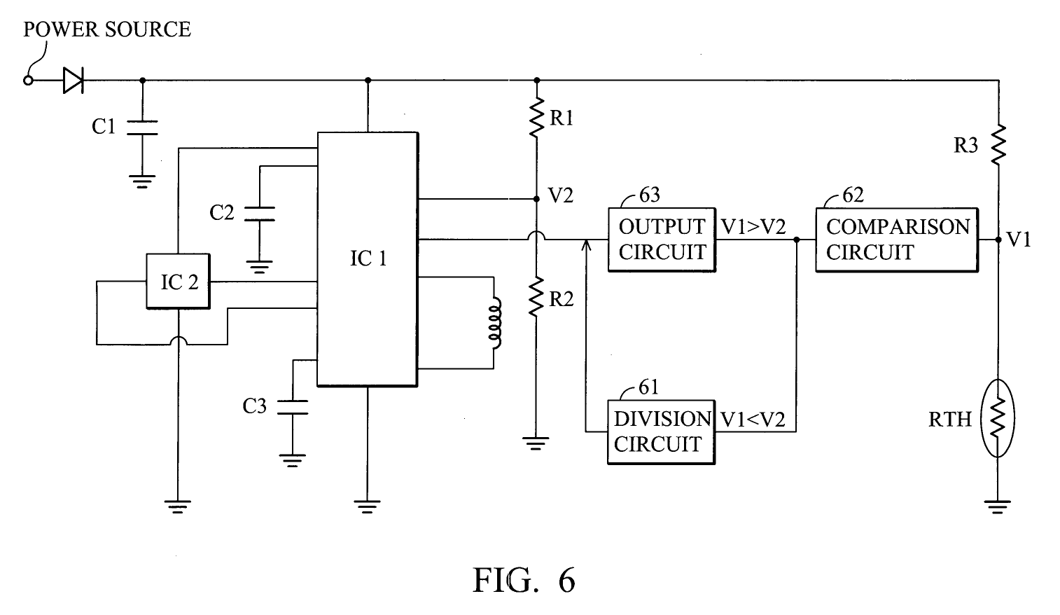

FIG. 6 is a schematic diagram of the fourth embodiment of the motor speed control device of the present invention. As shown in FIG. 6, the detailed circuit and control theory are similar to those in the first embodiment. The difference between these two embodiments lies in the switch circuit of the first embodiment being replaced with a division circuit 61, a comparison circuit 62, and an output circuit 63.

When the second voltage (or the reference voltage) V2 is smaller than the first voltage V1, the output circuit 63 outputs a voltage equal to the second voltage V2 to the circuit IC1 so as to keep the fan at a low speed. When the second voltage V2 exceeds the first voltage V1, the voltage input to the circuit IC1 divided by N (N is a natural number) through the division circuit 61. Therefore, the desired voltage (Vcc×16%) is rapidly achieved for stably controlling the rotation speed when the fan functions at a low speed.

In conclusion, the motor speed control device is applied to a DC fan for effectively and stably controlling different speeds (from low to full) and the rotation speed in different temperature ranges.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A motor speed control device, applied to a fan, comprising:
a thermal sensor detecting an environmental temperature of the fan;
a driving element driving the fan to a specific speed according to the detected temperature; and
a control element connected electrically between the driving element and the thermal sensor for adjusting a first voltage of the thermal sensor to change a rotation speed and a temperature range of the fan.

2. The motor speed control device as claimed in claim 1, wherein the thermal sensor is a thermistor.

3. The motor speed control device as claimed in claim 1, wherein the driving element comprises a Hall sensor and a driver IC.

4. The motor speed control device as claimed in claim 1, wherein the control element is a switch circuit.

5. The motor speed control device as claimed in claim 4, wherein the switch circuit comprises a comparator, a transistor, and two resistors.

6. The motor speed control device as claimed in claim 5, wherein one resistor of the switch circuit is electrically connected in parallel with the thermal sensor such that the first voltage rapidly decreases below a reference voltage of the driving element to turn on the transistor and reduce the temperature range of the fan to a full speed.

7. The motor speed control device as claimed in claim 1, wherein the control element is a resistor electrically connected in serial with the thermal sensor and controlling the temperature range of the fan to a full speed by adjusting a resistance of the resistor and reducing a variation of the first voltage.

8. The motor speed control device as claimed in claim 1, wherein the control element is a subtraction circuit.

9. The motor speed control device as claimed in claim 8, wherein the subtraction circuit comprises a comparator and at least four resistors.

10. The motor speed control device as claimed in claim 9, wherein three resistors of the subtraction circuit generate a second voltage to adjust a third voltage output to the driving element so as to reduce the temperature range of the fan to a full speed.

11. The motor speed control device as claimed in claim 1, wherein the control element comprises a division circuit, a comparator, and an output circuit.

12. The motor speed control device as claimed in claim 11, wherein when the first voltage exceeds a reference voltage of the driving element, the output circuit outputs a voltage equal to the reference voltage to the driving element so as to keep the fan at a relatively low speed.

13. The motor speed control device as claimed in claim 12, wherein when the first voltage is less than the reference voltage of the driving element, a voltage input to the driving element is divided by N through the division circuit to rapidly drive the fan to a full speed, wherein N is a natural number.

14. A motor speed control device, applied to a fan, comprising:
a thermal sensor detecting an environmental temperature of the fan;
a driving element driving the fan to a specific speed according to the detected temperature; and
a control element connected electrically between the driving element and the thermal sensor for adjusting a first voltage of the thermal sensor, wherein the control element is a switch circuit, and a resistor of the switch circuit is electrically connected in parallel with the thermal sensor such that the first voltage rapidly decreases below a reference voltage of the driving element, reducing a temperature range of the fan to a full speed.

15. A motor speed control device, applied to a fan, comprising:
a thermal sensor detecting an environmental temperature of the fan;
a driving element driving the fan to a specific speed according to the detected temperature; and
a control element connected electrically between the driving element and the thermal sensor for adjusting a first voltage of the thermal sensor, wherein the control element is a resistor electrically connected in serial with the thermal sensor for controlling a temperature range of the fan to a full speed by adjusting a resistance of the resistor and reducing a variation of the first voltage.

16. A motor speed control device, applied to a fan, comprising:
a thermal sensor detecting an environmental temperature of the fan;
a driving element driving the fan to a specific speed according to the detected temperature; and
a control element connected electrically between the driving element and the thermal sensor for adjusting a first voltage of the thermal sensor, wherein the control element is a subtraction circuit, and three resistors of the subtraction circuit generate a second voltage to adjust the first voltage to reduce a temperature range of the fan to a full speed.

17. A motor speed control device, applied to a fan, comprising:
a thermal sensor detecting an environmental temperature of the fan;
a driving element driving the fan to a specific speed according to the detected temperature; and
a control element connected electrically between the driving element and the thermal sensor for adjusting a first voltage of the thermal sensor, wherein when the first voltage exceeds a reference voltage of the driving element, the control element outputs a voltage equal to the reference voltage to be input to the driving element so as to keep the fan at a relatively low speed, and when the first voltage is smaller than the reference voltage of the driving element, the voltage input to the driving element is divided by N through the control element to quickly increase the fan to a full speed, wherein N is a natural number.
